(19) United States
(12) Patent Application Publication
(10) Pub. No.: US 2004/0229990 A1
(43) Pub. Date: Nov. 18, 2004

(54) Acrylic structural adhesive having improved T-peel strength

(75) Inventors: Robin F. Righettini, Chester, SC (US); Jeffrey A. Hatcher, Holly Springs, NC (US); Jian-Ping Huang, Apex, NC (US)

Correspondence Address: LORD CORPORATION, PATENT & LEGAL SERVICES, 111 LORD DRIVE, CARY, NC, 27512, US

(73) Assignee: Lord Corporation

(21) Appl. No.: 10/439,520

(22) Filed: May 16, 2003

(51) Int. Cl. C08K 5/24; C08K 5/04; C08K 5/09; C08K 3/34

(52) U.S. Cl. 524/445; 156/330; 156/221; 524/449; 524/394; 524/261; 524/492

(57) ABSTRACT

Epoxy-modified, two-part acrylic structural adhesives represented by an A-side in a preferred embodiment containing a monomer selected from group (a) and (b), wherein (a) is 4-(C₃-C₁₀ alkyl) cyclohexylmethacrylate, 2,5-(C₁-C₆ alkyl) disubstituted cyclohexylmethacrylate, 3,5-(C₁-C₆ alkyl) disubstituted cyclohexylmethacrylate. 3,3,4-(C₁-C₄ alkyl) tri-substituted cyclohexylmethacrylate, 3,3,5-(C₁-C₄ alkyl) tri-substituted cyclohexylmethacrylate, 3,3,5,5-(C₁-C₄ alkyl) tetra-substituted cyclohexylmethacrylate, and (b) is C₇-C₁₀ alkyl methacrylates selected from bornyl (C₁₀H₁₇ cyclo) methacrylate, and isobornyl methacrylate; a multifunctional crosslinking monomer, a cure rate modifier, an inorganic filler, an adhesion promoter, a reactive diluent, a solid and/or liquid toughener, and a reducing agent; and a B-side containing an epoxy resin, an oxidizer, a non-reactive liquid carrier, an inorganic filler, a thixotropic agent, optional plasticizer in addition to said liquid carrier; and an optional liquid elastomer modified epoxy.

### BACKGROUND

Acrylic structural adhesives are extensively used for providing structural strength-imparting bonds to joined metal and/or polymer materials. Acrylic structural adhesives are useful for bonding metal parts partially in place of welding or mechanical fastening techniques. The structural requirements include high bond strength, fracture energy, and good failure mode. One prevalent use for acrylic structural adhesives is in forming hem flanges in automotive body panels and doors. In this application field methods for measuring bond performance include the T-peel test and high speed impact wedge peel test (IWP). Exemplary conventional acrylic structural adhesives and methods for using acrylic structural adhesives are disclosed in the following background U.S. Patents: 6,180,199 entitled Beaded Adhesive And Hem Flanged Part Made Therefrom; and 6,225,408 entitled Adhesive Formulations.

Conventional acrylic structural adhesives typically comprise a mixture of one or more olefinic reactive monomers such as methyl methacrylate and methacrylic acid, toughener(s) and a redox initiator system. The toughener may or may not be reactive, or polymerizable with the reactive monomers. Reactive polymers such as unsaturated polyesters or acrylourethane prepolymers, or acrylated rubber may be used to copolymerize with the monomers, either grafting onto or crosslinking with the polymer network. In addition, fully formulated acrylic structural adhesives typically contain other additives for improving adhesion to substrate materials, environmental resistance, impact strength, flexibility, heat resistance, shelf stability, and the like. Epoxy resins are optionally included to impart improved heat resistance.

U.S. Pat. No. 5,641,834 and U.S. Pat. No. 5,710,235, disclose adhesives that include as tougheners an olefinic-terminated polyalkadiene that includes carboxy ester linking groups and at least one nascent secondary hydroxyl group that is capped with a monoisocyanate. The tougheners disclosed are olefinic-terminated liquid elastomer produced from a hydroxyl-terminated polyalkadiene and isocyanate-capped methacrylate-terminated polyalkadiene produced from a hydroxyl-terminated polyalkadiene. The composition also includes a free radical-polymerizable monomer such as an olefinic monomer and, optionally, a second polymeric material. In a preferred embodiment the composition is an adhesive that also includes a phosphorus-containing compound and an ambient temperature-active redox catalyst.

Huang, Righettini and Dennis disclose in U.S. Pat. No. 6,225,408 as the curable adhesive portion a mixture of 10-90% by weight of at least one free radical-polymerizable monomer, optional adhesion promoter, a primary toughener with a weight average molecular weight (M_{w}) less than about 18,000 and an auxiliary toughener with a M_{w} greater than about 18,000.

Peel strength and impact strength of the current acrylic structural adhesives leaves room for improvement. In investigating different principal methacrylic ester monomers from among the myriad methacrylates, many are disqualified due to objectionable odor or lower T-peel strength on galvanized steels. A state of the art epoxy modified acrylic based upon tetrahydrofurfuryl methacrylate yields 39-41 pounds per linear inch T-peel strength on electrogalvanized steel. Substitution of certain alcohols in the ester moiety of the methacrylate esterification lead to surprising improvements in T-peel and impact strength, and these monomers providing improved T-peel and impact strength do not exhibit objectionable odor.

### SUMMARY

In one aspect, the invention resides in an ambient temperature curing epoxy-modified two-part acrylic structural adhesive characterized by improved T-peel strength, and in that the weight percent of epoxy resin based on the weight of parts A and B of the adhesive is in a range of from 3% to 6%. These adhesives are not inhibited by oxygen. In a 2-pack dispensing system, where parts A and B are mixed in a nozzle equipped with a static mixer, the A and B parts are combined in a mix ratio of 6:1-14:1 by volume, preferably from 8:1 to 12:1 and most preferably 9:1-11:1.

In another aspect, the invention is a 2-part acrylic structural adhesive exhibiting improved T-peel strength and high speed impact wedge peel strength and rapid ambient curing via radical polymerization,

(A) in a first package, contains on a weight basis, from about 10 to about 90 percent by weight of at least one methacrylate mononmer selected from the groups 1) and 2)

1) C₃-C₁₀ alkyl monosubstituted (in 4-position)-, C₁-C₆ alkyl disubstituted-(in 2,5 and 3,5 positions), C₁-C₄ alkyl tri-substituted (in the 3,3,5 or 3,4,5 positions), and C₁-C₄ alkyl tetra-substituted (in 3,3,5,5 positions) cyclohexyl methacrylate, and

2) C₇-C₁₀ alkyl methacrylates selected from bornyl (C₁₀H₁₇) methacrylate, and isobornyl methacrylate;

from about 10 to about 80 percent by weight of a toughener, from 0 to 15% of an adhesion promoter.

(B) in a second package, a bonding activator, and epoxy resin, wherein the weight ratio of toughener to epoxy resin is from 4:1 to 11:1.

An exemplary two-part acrylic structural adhesive applied as a 10:1 volume ratio of A-side to B-side, comprises:

in the A-side or fist package:

(a) 10-90, preferably 20-70, weight percent of an olefinic monomer selected from the group consisting of (meth)acrylic acid; esters, amides or nitriles of (meth)acrylic acid; maleate esters; fumarate esters; vinyl esters; conjugated dienes; itaconic acid; styrenic compounds; and vinylidene halides;

(b) 20-50, preferably 30-40, weight percent of a primary toughener;

(c) 0-15, preferably 1-10, weight percent of an auxiliary toughener;

(d) 0-20, preferably 2-6, weight percent of a phosphorus adhesion promoter compound having one or more olefinic groups,

(e) 0.05-10, preferably 0.1-6, weight percent of at least one reducing agent which is interactive with an oxidizing agent to produce free radicals at room temperature and initiate polymerization; and in the B-Side or second package, epoxy resin, a bonding activator containing an oxidizing agent of redox initiation system, the oxidizing agent being reactive at room temperature with the reducing agent in the A-side, and the epoxy resin is in an amount of from 3-6 wt % on total weight of A- and B-sides.

In a preferred embodiment of the present invention there is provided a two-part adhesive system comprising on a weight basis in the A-side:

(i) from 15 to 35% of a monomer selected from C₃-C₁₀ alkyl monosubstituted (in 4-position) cyclohexylmethacrylate, C₁-C₆ alkyl disubstituted (in 2,5 or 3,5 positions) cyclohexylmethacrylate, C₁-C₄ alkyl tri-substituted (in the 3,3,5 or 3,4,5 positions) cyclohexylmethacrylate, and C₁-C₄ alkyl tetra-substituted (in 3,3,5,5 positions) cyclohexylmethacrylate, bornyl methacrylate, and isobornyl methacrylate;

(ii) from 2 to 10% of multifunctional crosslinking monomer

(iii) from 0 to 0.25% of a cure rate modifier

(iv) from 15 to 30% of inorganic filler

(v) from 1 to 6% of an adhesion promoter;

(vi) from 1 to 10% of a reactive diluent and

(vii) from 30 to 42% of solid and/or liquid rubber toughener(s)

(viii) from 0.01 to 10% of a reducing agent; the sum of (i) to (viii) to 100 wt. %;

and in the B-Side

(i) from 40 to 70% of an epoxy resin,

(ii) from 3 to 12% of an oxidizer,

(iii) from 3 to 12% of a non-reactive liquid carrier,

(iv) from 10 to 40% of an inorganic filler,

(v) from 2 to 8% of a thixotropic agent, from 0 to 8% of plasticizer in addition to liquid carrier; and

(vi) from 0 to 10% of an epoxy capped liquid elastomer polymer.

The invention is also a method to join first and second steel panels. The method comprises the steps of:

a) applying to the second panel any of the above 2-part adhesives in a bead line parallel and proximate to a panel edge on a fold or panel edge to be folded,

b) aligning an edge of the first panel over the adhesive bead line, and pressing the folded edge of said second panel over the edge of said first panel in a hemming step, causing said panels to sandwich said adhesive spreading it within the bond area, and

c) completing the folding of the edge of the second panel by applying pressure.

### DESCRIPTION OF THE PREFERRED EMBODIMENTS

Monomer

In the general embodiment containing a specified amount of epoxy resin, the A-side of the two-part reactive acrylic structural adhesive contains 10-90% by weight of at least one free radical-polymerizable monomer in a major amount (the primary monomer). Representative monomers include esters of (meth)acrylic acid such as methyl methacrylate(MMA), ethyl methacrylate, butyl methacrylate, methyl acrylate, butyl acrylate, cyclohexyl acrylate, hexyl acrylate, 2-ethylhexyl acrylate, lauryl acrylate, ethyl acrylate, diethylene glycol dimethacrylate, dicyclopentadienyloxyethyl methacrylate, cyclohexyl methacrylate, lauryl methacrylate, glycidyl methacrylate and tetrahydrofurfuryl methacrylate (THFMA). The major monomer may be combined with an ethylenic unsaturated carboxylic monomer such as methacrylic acid (MAA), acrylic acid, substituted (meth)acrylic acids such as itaconic acid. Further optional comonomers includable herein are acrylonitrile, methacrylonitrile, acrylamide and methacrylamide; styrene; substituted styrenes such as vinyl styrene, chlorostyrene, methyl styrene and n-butyl styrene; vinyl acetate; vinylidene chloride; and substituted butadienes such as 2,3-dichloro-1,3-butadiene and 2-chloro-1,3-butadiene. Other useful monomers include maleate esters; fumarate esters; and styrenic compounds such as styrene, chlorostyrene, methylstyrene, butylstyrene and vinyl styrene. In one embodiment, a mixture of the monomers tetrahydrofurfuryl methacrylate, methacrylic acid and methyl methacrylate is useful. It is preferred to include a reactive diluent with the primary monomer. In one embodiment the preferred reactive diluent is (meth)acryloyl substituted dibasic acid, such as hydroxyethyl methacryloyl phthalate (HEMA-phthalate).

Comonomers optionally includable with the primary monomer include-OH-functional monoethylenic unsaturated monomers like 3-hydroxypropyl (meth)acrylate, 4-hydroxybutyl (meth)acrylate, 4-hydroxycyclohexyl(meth) acrylate, 1,6-hexanediol mono(meth) acrylate, neopentyl glycol mono(meth)acrylate. Preferedly from 2-10 wt % (on wt. of A-side) of a multifunctional crosslinking monomer is included, such as 1,4-butanediol diacrylate, 1,6-hexanediol diacrylate, trimethylolpropane triacrylate, pentaerythritol triacrylate, 1,2-ethanediol diacrylate, trimethylolpropane tri(meth) acrylate, hexanediol dimethacrylate, trimethylolethane tri(meth) acrylate, pentaerythritol tetra(meth) acrylate, polyethylene glycol diacrylates, and epoxy-diacrylates such as bisphenol A dimethacrylate and ethoxylated bisphenol A dimethacrylate.

The preferred primary monomer contained in the A-side is distinguished by the moiety in the ester portion. The primary monomer exhibits a homopolymer Tg of equal or above 105° C. The amount of monomer present is about 10 to about 90 percent by weight of the A-side, and is at least one methacrylate selected from the groups 1) and 2) where group 1) is C₃-C₁₀ alkyl monosubstituted (in 4-position) cyclohexylmethacrylate, C₁-C₆ alkyl disubstituted (in 2,5 or 3,5 positions) cyclohexylmethacrylate, C₁-C₄ alkyl tri-substituted (in 3,3,5 or 3,4,5 positions) cyclohexylmethacrylate, or C₁-C₄ alkyl tetra-substituted (in 3,3,5,5, positions) cyclohexylmethacrylate, and group 2) includes linear or branched C₄-C₁₀ alkyl methacrylates. Specific examples of group 1) and 2) include 4-t-butyl-cyclohexylmethacrylate (t-BCHMA); 2-isopropyl 5-methyl cyclohexylmethacrylate (iPMCHMA); 3,5-dimethyl cyclohexylmethacrylate (DMCHMA), 3,3,5-trimethylcyclohexyl methacrylate (TMCHMA); 3,4,5-trimethylcyclohexyl methacrylate; 3,3,5,5-tetramethylcyclohexyl methacrylate, bornyl (C₁₀H₁₇) methacrylate, and isobornyl methacrylate. The substituents on the cyclohexyl ring of the alcohol transesterified with the α,β-unsaturated acid are preferably in either the 2, 3, 4, and/or 5 position. C₁-C₆ alkyl denotes linear or branched alkyl, such as methyl, ethyl, propyl, isopropyl, butyl, isobutyl, pentyl and hexyl. Specific examples of the preferred monomers include 3,3,5-trimethylcyclohexyl methacrylate, 4-tert-butylcyclohexyl methacrylate, 3,3,5,5-tetramethylcyclohexyl methacrylate, 3,4,5-trimethylcyclohexyl methacrylate, bornyl (C₁₀H₁₇ cyclic) methacrylate, and isobornyl methacrylate.

Tougheners

Any suitable elastomer toughener can be utilized in the structural adhesives according to the inventions. The toughener examples include various solid and liquid elastomeric polymeric materials, and in particular liquid olefinic-terminated elastomers as described in U.S. Pat. Nos. 4,223,115; 4,452,944; 4,769,419; 5,641,834 and 5,710,235; and olefinic urethane reaction products of an isocyanate-functional prepolymer and a hydroxy functional monomer, as described in U.S. Pat. Nos. 4,223,115; 4,452,944; 4,467,071 and 4,769,419, the entire disclosure of each which is hereby incorporated by reference. A-B-A triblock block copolymers are useful tougheners. In one example the A block is polystyrene, alpha-methyl styrene, t-butyl styrene, or other ring alkylated styrenes as well as mixtures of some or all of the above and the B block is an elastomeric segment having a Tg of 0° C. or less, such as that derived from a conjugated diene, butadiene, isobutylene, and their hydrogenated polymers, or other olefins, like ethylene and propylene monomers. Commercially available block copolymer tougheners include EUROPRENE® which are available from Enichem Elastomers Americas, Inc., and Kraton® available from Kraton Polymers LLC. A preferred toughener is based on a terblock polymer of styrene-isoprene-styrene, 12.5-50-12.5 parts by weight. Other high molecular weight tougheners include, for example, block copolymers, core-shell copolymers and random copolymers including but not limited to polyethylene, polypropylene, polybutadiene, styrene-butadiene copolymer, polychloroprene, MABS, MBS, and EPDM polymers, chlorinated rubber, butyl rubber, styrene/butadiene/acrylonitrile rubber and chlorosulfonated polyethylene.

Other tougheners include the liquid olefinic-terminated elastomers, wherein the elastomeric moiety is based on homopolymers of butadiene, hydrogenated butadiene homopolymers, copolymers of butadiene and at least one monomer copolymerizable therewith, for example, styrene, acrylonitrile, e.g. poly(butadiene-acrylonitrile) or poly(butadiene-acrylonitrile-styrene) and mixtures thereof; as well as modified elastomeric polymeric materials, such as butadiene homopolymers and copolymers modified by copolymerization therewith of trace amounts of up to about 5 percent by weight of the elastomeric material of at least one functional monomer (such as acrylic acid, methacrylic acid, maleic anhydride, fumaric acid, styrene, and methyl methacrylate to give, for example, methacrylate-terminated polybutadiene homopolymers and/or copolymers.

Inclusive as tougheners are the olefinic-terminated polyalkadienes having carboxy ester linking groups and at least one nascent secondary hydroxyl group, such as disclosed in U.S. Pat. No. 5,587,433, incorporated herein by reference. The secondary OH group may be optionally caped using a monoisocyanate as is disclosed in commonly owned U.S. Pat. No. 5,641,834, incorporated herein by reference.

Specific examples of adducted hydroxy-terminated polybutadiene include the reaction of anhydride modified OH-terminal polybutadiene with an epoxy, such as glycidal methacrylate, and adduct of glycidal methacrylate and carboxy-terminated polybutadiene. Polybutadiene collectively refers to homopolymers of butadiene and copolymers, such as butadiene, acrylonitrile copolymers, well known in the art.

A preferred toughener system utilizes a combination of two tougheners having differing molecular weights, as is taught in U.S. Pat. No. 6,225,408. A specific example taught therein is combination of a major amount of a primary toughener with a weight average molecular weight (M_{w}) less than about 18,000. In one embodiment of the present invention, a primary toughener as liquid polybutadiene and auxiliary as solid terblock copolymer is present in a weight ratio of primary to an auxiliary toughener of from 5:1 to 20:1 where the auxiliary toughener has a M_{w}, greater than about 18,000. A specific example is a mixture of glycidal methacrylate terminated CTBN rubber in a 5:1 to 20:1 ratio to a terblock copolymer of styrene-isoprene-styrene, 12.5-75-12.5 parts by weight.

An effective amount of toughener on a weight basis of the A-side of the adhesive ranges from 30% to 42%, and preferably 34 to 38%. Significant improvement in T-peel strength was found in the two-part adhesive containing an overall weight ratio of elastomer toughener to epoxy resin in a range of from 4:1 to 11:1. In a weight ratio of less than 4:1, the impact strength and T-peel strength of the cured adhesive is negatively affected. If the ratio is above 11:1, lap sheer strength of the cured adhesive is negatively impacted. The more preferred rubber toughener is a combination of liquid methacryl terminated polybutadiene and solid rubber polymer having a M_{w}, of from 20,000 to 500,000.

Reactive Diluent

As pointed out above, the preferred embodiments contain a reactive diluent. Representative known reactive diluents include (meth)acryloyl substituted carboxylic acid; reaction of an unsaturated oxirane with a carboxylic acid; a 1,4-dioxo-2-butene-functional compound, and the like. Known useful reactive diluents are described in U.S. Pat. Nos. 6,541,657, 6,252,023, and 6,562,190. Preferred reactive diluent is a half ester, or half amide of a dicarboxylic acid esterified with hydroxy functional acrylate or methacrylate monomer. Aslo suitable are α-methylstyrene terminated oligomers, such as the reaction product of 3-isopropenyl-α,α-dimethylbenzyl isocyanate and an amine terminated polyethers, as taught in U.S. Pat. No. 6,479,602. The most preferred reactive diluent is the methacrylate half ester of a dicarboxylic acid anhydride. Examples of suitable hydroxy-functional (meth)acrylate compounds include 2-hydroxyethyl acrylate, 2-hydroxyethyl methacrylate, 2-hydroxypropyl acrylate, 2-hydroxypropyl methacrylate, 2-hydroxybutyl acrylate, 2-hydroxybutyl methacrylate, 3-hydroxypropyl acrylate, 4-hydroxybutyl acrylate, 3-hydroxypentyl acrylate, 6-hydroxynonyl acrylate, 3-hydroxypropyl methacrylate, 2-hydroxypentyl methacrylate, 5-hydroxypentyl methacrylate, 7-hydroxyheptyl methacrylate, 5-hydroxydecyl methacrylate, N-hydroxymethyl acrylamide, N-hydroxymethyl methacrylamide, diethylene glycol monoacrylate, diethylene glycol monomethacrylate, glycerin dimethacrylate, trimethylol propane dimethacrylate, alkoxylated hydroxyethyl acrylate, trimethylolpropane diacrylate, alkoxylated trimethylolpropane diacrylate, reaction products of polyether glycols of acrylic or methacrylic acid and the like.

Other hydroxy-functional acrylate compounds are lactone-modified acrylate or methacrylate acid esters (hereinafter “lactone-acrylate adducts”) prepared by reacting an appropriate lactone with a hydroxy-functional acrylate compound defined in the preceding paragraph as is known in the art. Lactones employed in the preparation of the lactone-acrylate adducts may be the same as the lactones defined above with respect to the preparation of the lactone-based polyester polyols. An example of a lactone-acrylate adduct is a 2-hydroxyethyl acrylate-caprolactone adduct such as TONE® M-100.

The known acid or anhydride suitable for reacting with the hydroxy functional (meth)acrylate compound are based on, for example, oxalic, fumaric, itaconic, aconitic, maleic, malonic, succinic, phthalic, isophthalic, terephthalic, alkylsuccinic, glutaric, adipic, pimelic, suberic, azelaic, sebacic, undecandioic, dodecandioic, brassilic, dimer acids, and the like. The most preferred reactive diluent is mono-2-(methacryloyloxy)ethyl phthalate (HEMA-phthalate) commercially available from International Specialty Chemicals under the trade designation BISOMER® EMP, or Sartomer® CD-400. An effective amount of reactive diluent in weight % on the weight of adhesive ranges from 1% to 10%, and preferably from 2% to 6%.

Adhesion Promoter

Adhesion promoters useful herein are the known alkenyl functional silanes, having an unsaturated organic moiety bonded to the silicone atom, for example an unsaturated acrylic, vinyl, allyl, methallyl, propenyl, hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl or styryl groups. Other alkenyl functional organometallics include titanates, such as vinylalkyl titanates, zirconates, zinc diacrylate, and zinc dimethacrylates. Preferred are phosphorus-containing compounds with mono-esters of phosphinic, mono-and diesters of phosphonic and phosphoric acids having one unit of acrylic unsaturation present being especially preferred. Adhesion promoters preferably contain two different polymer-reactive groups, such as unsaturated and silane groups, unsaturated and hydroxyl groups, unsaturated and acidic groups, and unsaturated and isocyanate groups. Acrylic unsaturation is preferred. Representative of the reactive phosphorus-containing adhesion promoters are, without limitation, phosphoric acid; 2-methacryloyloxyethyl phosphate; bis-(2-methacryloxyloxyethyl)phosphate; 2-acryloyloxyethyl phosphate; bis-(2-acryloyloxyethyl)phosphate; methyl-(2-methacryloyloxyethyl)phosphate; ethyl methacryloyloxyethyl phosphate; methyl acryloyloxyethyl phosphate; ethyl acryloyloxyethyl phosphate; propyl acryloyloxyethyl phosphate, isobutyl acryloyloxyethyl phosphate, ethylhexyl acryloyloxyethyl phosphate, halopropyl acryloyloxyethyl phosphate, haloisobutyl acryloyloxyethyl phosphate or haloethylhexyl acryloyloxyethyl phosphate; vinyl phosphonic acid; cyclohexene-3-phosphonic acid; α-hydroxybutene-2 phosphonic acid; 1-hydroxy-1-phenylmethane-1,1-diphosphonic acid; 1-hydroxy-1-methyl-1-disphosphonic acid: 1-amino-1 phenyl-1,1-diphosphonic acid; 3-amino-1-hydroxypropane-1,1-disphosphonic acid; amino-tris(methylenephosphonic acid); gamma-amino-propylphosphonic acid; gamma-glycidoxypropylphosphonic acid; phosphoric acid-mono-2-aminoethyl ester; allyl phosphonic acid; allyl phosphinic acid; β-methacryloyloxyethyl phosphinic acid; diallylphosphinic acid; and allyl methacryloyloxyethyl phosphinic acid. A preferred adhesion promoter is 2-hydroxyethylmethacrylate phosphate.

The reactive phosphorus-containing compounds are also illustrated by the formula:

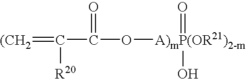

wherein R²⁰ is selected from the group consisting of hydrogen, an alkyl group having from one to 8, preferably one to 4, carbon atoms, and CH₂CH—; R²¹ is selected from the group consisting of hydrogen, an alkyl group having from one to 8, preferably one to 4 carbon atoms; A is selected from the group consisting of —R²²O- and R²³O)ₙ, wherein R²² is an aliphatic or cycloaliphatic alkylene group containing from one to 9, preferably 2 to 6, carbon atoms; R²³ is an alkylene group having from one to 7, preferably 2 to 4, carbon atoms; n is an integer from 2 to 10, and m is one or 2, preferably one. An effective amount of unsaturated phosphorus-containing compound on a weight % of A-side of the adhesive is from 1% to 10%, preferably from 2% to 6%. Inclusion of amount in excess of 10% by weight unduly retards the adhesive rate of cure.

Initiator System

The initiator system includes at least one oxidizing agent in the B-side and at least one reducing agent in the A-side. This system is co-reactive at ambient conditions on mixture of the A and B sides to initiate free radical polymerization reactions and cure the adhesive. Substantially any of the known oxidizing and reducing agents which are co-reactive at ambient conditions in air can be employed.

The reducing agent (bonding accelerator) is in the A-side at a typical suggested level of from 0.01 to 10 wt. % of the A side, and preferably is used at from 0.5 to 5 percent by weight, based on the total weight of A-side components. Representative reducing agents include, without limitation, sulfinic acids; azo compounds such as azoisobutyric acid dinitrile; alpha-aminosulfones such as bis(tolysulfonmethyl)-benzyl amine; aromatic tertiary amines such as N,N-diisopropanol-p-methyl aniline; N,N-dimethyl aniline, and N,N-diethanol-p-dimethyl aniline, and aminealdehyde condensation products, for example, the condensation products of aliphatic aldehydes such as butyraldehyde with primary amines such as aniline or butylamine. Preferred reducing agents are N,N-dimethyl aniline, N,N-dimethylaminomethylphenol, N,N-bis(2-hydoxyethyl)-p-toluidine (Emery® 5710), and N,N-Bis(2-hydroxyethyl)-m-toluidine (Emery® 5709) from Cognis Corporation.

Preferred reducing agents can be illustrated by the structure

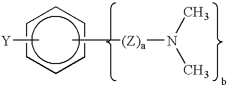

wherein Z is methylene; Y is selected from the group consisting of hydrogen, hydroxy, amino, halogen, alkyl having 1 to 8, preferably 1 to 4, carbon atoms, and alkoxy having 1 to 8, preferably 1 to 4, carbon atoms; a is 0 or 1, preferably 0; and b is 1 or 2. Specific examples where Y=halogen are N,N-diisopropanol-p-chloroaniline; N,N-diisopropanol-p-bromoaniline; N,N-diisopropanol-p-bromo-m-methylaniline; N,N-dimethyl-p-chloroaniline; N,N-dimethyl-p-bromoaniline; N,N-diethyl-p-chloroaniline; and N,N-diethyl-p-bromoaniline.

According to specific embodiment of the invention, the A-side contains a parahalogenated tertiary amine reducing agent having the formula:

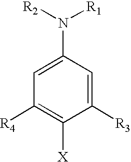

wherein each of R₁ and R₂, which may be the same or different, is independently selected from the group consisting of linear or branched, saturated or unsaturated, C₁-C₁₀ alkyl and linear or branched, saturated or unsaturated, C₁-C₁₀ hydroxyalkyl (i.e., alkyl substituted by -OH); each of R₃ and R₄ is independently selected from the group consisting of hydrogen and linear or branched, saturated or unsaturated C₁-C₁₀ alkyl; and X is halogen, preferably chlorine.

Representative bonding activators for the B-side are oxidizing agents including, without limitation, organic peroxides, such as benzoyl peroxide and other diacyl peroxides, hydroperoxides such as cumene hydroperoxide, peresters such as β-butylperoxybenzoate; ketone hydroperoxides such as methyl ethyl ketone hydroperoxide, organic salts of transition metals such as cobalt naphthenate, and compounds containing a labile chlorine such as sulfonyl chloride. Preferably, in adhesives using a volume mix ratio of 10:1, the oxidizing agent will be present in an amount in the range from about 0.5 to about 50 percent by weight of bonding accelerator, with the amount of reducing agent being in the range from about 0.05 to about 10 preferably about 0.1 to about 6, percent by weight of polymerizable adhesive composition. DIHPT is a preferred reducing agent. The most preferred oxidizing agent is benzoyl peroxide.

The carrier vehicles is present in the B-side from about 30 to about 99.5 percent by weight, based on total weight of B-side can include a carrier vehicle. Well-known carriers for peroxide initiators as non-reactive with the monomers, include phthalate esters, e.g., butyl benzyl phthalate. The preferred liquid carriers are non-phthalate compounds such as adipate esters, mixtures of adipate ester and polyester, and benzoate esters.

The carrier vehicles which are suitable for use in the bonding activators can be a simple inert solvent or diluent such as methylene chloride, or butyl benzyl phthalate, including mixtures of such solvents or diluents. The carrier vehicle should contain no more than 5% by weight of any moiety which is reactive with the oxidizing agent at room temperature. The carrier vehicle can alternatively be a more complex mixture including at least one film-forming binder in addition to inert solvent or diluent. The carrier vehicle can contain, in addition to solvent or solvent and film-forming binder, additional additives such as external plasticizers, flexibilizers, suspenders and stabilizers, providing that any such additives do not unacceptably adversely affect the stability of the activator composition.

Epoxy Resin

The epoxy compound of the present invention can be any resinous material that contains an epoxy (oxirane) group. Included epoxy resins are epoxy cresol novolacs, epoxy phenol novolacs and blends of either of these with Bisphenol-A epoxy resins. Monomeric epoxy compounds and epoxides of the polymeric type can be aliphatic, cycloaliphatic, aromatic, or heterocyclic. The “average” number of epoxy groups per molecule is determined by dividing the total number of epoxy groups in the epoxy-containing material by the total number of epoxy molecules present. Useful epoxy materials generally contain on the average at least 1.5 polymerizable epoxy groups per molecule. Preferably two or more epoxy groups per molecule are present. The polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendent epoxy groups (e.g., a glycidyl methacrylate polymer or copolymer). The epoxides may be pure compounds, but are generally mixtures containing one, two, or more epoxy groups per molecule.

The epoxy-containing materials may vary from low molecular weight, monomeric materials to high molecular weight polymers. They may vary greatly in the nature of their backbone and substituents groups. For example, the backbone may be of any type and substituents groups thereon being free of an active hydrogen atom. Illustrative of permissible substituents groups include halogens, ester groups, ethers, sulfonate groups, siloxane groups, nitro groups, phosphate groups, etc. The molecular weight of the epoxy-containing materials may vary from about 50 to 100,000 or more. Mixtures of various epoxy-containing materials can also be used in the compositions of this invention.

The epoxy compounds of the present invention can be cycloaliphatic epoxides. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, bis(3,4-epoxycyclohexylmethyl)pimelate, and the like. Other suitable diepoxides of cycloaliphatic esters of dicarboxylic acids are described in, for example, U.S. Pat. No. 2,750,395, which is incorporated herein by reference.

Other cycloaliphatic epoxides include 3,4-epoxycyclohexylmethyl-3,4-epoxycyclohexane carboxylates such as 3,4-epoxycyclohexylmethyl-3,4-epoxycyclohexane carboxylate; 3,4-epoxy-1-methylcyclohexylmethyl-3,4-epoxy-1-methylcyclohexane carboxylate; 6-methyl-3,4-epoxycyclohexylmethyl-6-methyl-3,4-epoxycyclohexane carboxylate; 3-,4-epoxy-2-methylcyclohexylmethyl-3,4-epoxy-2-methylcyclohexane carboxylate; 3,4-epoxy-3-methylcyclohexylmethyl-3,4-epoxy-3-methylcyclohexane carboxylate; 3,4-epoxy-5-methylcyclohexylmethyl-3,4-epoxy-5-methylcyclohexane carboxylate and the like. Other suitable 3,4-epoxycyclohexylmethyl-3,4-epoxycyclohexane carboxylates are described in, for example, U.S. Pat. No. 2,890,194, which is incorporated herein by reference.

Epoxy resins based on Bisphenol-A, either solids, per se, and capable of dissolution in a carrier, or liquids per se, are preferred as these are relatively inexpensive.

There are a myriad of available epoxy materials, collectively referred to as epoxy resins whether resinous or simple compounds. In particular, simple epoxy compounds which are readily available include octadecylene oxide, glycidylmethacrylate, diglycidyl ether of bisphenol A (e.g., those available under the trade designations EPON from Resolution Performance Products (Houston, Tex.), DER, from Dow Chemical Co.) and ERL from Dow Chemical. Specific examples include vinylcyclohexene dioxide (e.g., ERL-4206), 3,4-epoxycyclohexylmethyl-3,4-epoxycyclohexane carboxylate (e.g., ERL-422), 3,4-epoxy-6-methylcyclohexylmethyl-3,4-epoxy-6-methylcyclohexene carboxylate (e.g., ERL-4201), bis(3,4-epoxy-6-methylcyclohexylmethyl) adipate (e.g. ERL-4289), bis(2,3-epoxycyclopentyl) ether (e.g., ERL-0400), aliphatic epoxy modified with polypropylene glycol (e.g., ERL-4050 and ERL-4052), dipentene dioxide (e.g., ERL-4269), epoxidized polybutadiene (e.g., OXIRON 2001 from FMC Corp.), silicone resin containing epoxy functionality, flame retardant epoxy resins (e.g., DER-580, a brominated bisphenol type epoxy resin available from Dow Chemical Co.), 1,4-butanediol diglycidyl ether of phenolformaldehyde novolak (e.g., DEN-431 and DEN-438 from Dow Chemical Co.), bisphenol A diglycidal ether (e.g., Araldite®, GY 6010 (Vantico), and resorcinol diglycidyl ether.

Still other epoxy-containing materials are copolymers of epoxy (meth)acrylic acid esters, such as glycidylacrylate and glycidylmethacrylate with one or more copolymerizable vinyl compounds. Examples of such copolymers are 1:1 styrene-glycidylmethacrylate, 1:1 methylmethacrylateglycidylacrylate and a 62.5:24:13.5 methylmethacrylate-ethyl acrylate glycidylmethacrylate, and CTBN modified epoxy resin, such as Epi-Rez® 58006 from Resin Solutions, Inc.

Optional Additives

The A-side can optionally include up to about 60, preferably not more than about 30, percent by weight based on the total weight of the composition of a polymeric component having an intrinsic viscosity of 0.1 to 1.3. These polymers can be obtained by the polymerization of at least one acrylic, styrene, substituted acrylic and non-acrylic olefinic monomers. Exemplary polymeric materials include poly(methyl methacrylate/n-butylacrylate/ethyl acrylate) (90/5/5); poly (n-butyl methacrylate/isobutyl methacrylate) (50/50); poly(n-butyl methacrylate), poly(ethyl methacrylate), and poly(tetrahydrofurfurylmethacrylate).

The adhesives can optionally contain a cure rate modifier. If present the cure rate modifier is effective at 0.005 to 0.25 weight percent, preferably 0.01 to 0.1 weight percent, based on the weight of the A part. The cure rate moderator is a vinyl aromatic compound, or vinyl aromatic terminated oligomer. The vinyl aromatic compounds as rate moderator comprise a vinyl functional group bonded to at least one aryl ring. The aromatic The compound can be substituted in the sense that another functional group can be bonded to the vinyl-functional group or the aryl ring. Preferably, the vinyl aromatic compound has a structure represented by the following formula:

(CX₂=CX)ₐ−Ar−(Z)_{b}

wherein each X is the same or different and is hydrogen, alkyl, aryl or halogen; Ar is at least one aryl ring; and Z is a substituents on any position of the aryl ring(s) and is alkyl, alkoxy, aryl, aryloxy, halogen, haloalkyl, haloaryl, alkylaryl, arylalkyl, alkanoyl, and oxyalkanoyl; a is 1 or 2; and b is 0 to 9, preferably 1 to 9. X preferably is hydrogen or methyl. Ar preferably is only one aryl ring, but may be up to three rings. Ar also can be an aryl ring that include a heteroatom such as nitrogen, oxygen or sulfur. Z preferably is an alkyl group such as methyl, ethyl or tert-butyl, a halogen such as chlorine or bromine, a haloalkyl such as chloromethyl, or an oxyalkanoyl such as acetoxy. A substituted vinyl aromatic compound (i.e., X is a group other than hydrogen and/or b is at least 1) is preferred. If the substituents groups X or Z contain carbon, the number of carbon atoms can be limited to a reasonable amount (such as 10) to prevent steric hindrance, reactivity or synthesis problems.

Illustrative vinyl aromatic compounds include α-methylstyrene, 3-methylstyrene,4-methylstyrene (i.e., vinyl toluene), 4-tert-butylstyrene, 4-methoxystyrene, 9-vinylanthracene, 2-bromostyrene, 3-bromostyrene, 4-bromostyrene, 4-acetoxystyrene, 4-benzyloxy-3-methoxystyrene, 4-chloromethylstyrene, 4-vinylpyridine, 1,1-diphenylethylene, styrene, α-methyl-p-methyl styrene, 2-vinyl pyridine and divinyl benzene. Especially preferred are α-methylstyrene and 4-methylstyrene.

Other optional additives which are typically considered in fully formulated adhesives include antioxidants, inhibitors, anti-sag additives, thixotropes, processing aids, waxes, UV stabilizers, arc suppressants, and drip suppressants. Examples of typical additives are fumed silica, or alumina thixotropic agent, hindered phenols and/or substituted hydroquinone stabilizer, and inorganic fillers such as silane-treated talc, mica, feldspar, titanium dioxide, calcium carbonate and wollastonite; and waxes such as paraffin wax, beeswax, ceresin wax and spermaceti wax.

Forms and Uses

Although the adhesive of the present invention may take many forms, the most preferred adhesive systems are provided as multipack or two-part adhesive systems where one package or part contains the polymerizable or reactive components and the reducing agent and a second package or part contains the oxidizing agent. The two parts are mixed together at the time of use in order to initiate the reactive cure. The preferred means for dispensing the adhesive are two-chambered cartridges equipped with static mixers in the nozzle, and for larger scale application, meter mix dispensing equipment. After mixing the individual packages, one or both surfaces to be joined are coated with the mixed adhesive system and the surfaces are placed in contact with each other.

The adhesive systems of the invention may be used to bond metal surfaces, such as steel, aluminum and copper, to a variety of substrates, including metal, plastics, and other polymers, reinforced plastics, fibers, glass, ceramics, wood and the like. The adhesives are particularly useful in hem flange bonding of auto body panels. It is a feature of the present invention that the herein-described adhesive compositions can be employed to bond metal substrates such as steel, aluminum and copper with little, if any, pretreatment of the metal surface prior to application of the adhesive. Thus, bonding can be effected even to oily metal surfaces which are otherwise clean without an extensive pretreatment as is usually required with the vast majority of currently available primers and adhesives. Additionally, the adhesive systems of this invention provide effective bonding at room temperature, thus heat is not required either for applying the adhesive systems to the substrates or for curing.

Although the adhesives of the present invention are preferred for bonding metal surfaces, the present adhesive compositions may be applied as an adhesive, primer or coating to any surface or substrate capable of receiving the adhesive. The metals which are preferred for bonding with the present adhesives include zinc, copper, cadmium, iron, tin, aluminum, silver, chromium, alloys of such metals, and metallic coatings or platings of such metals such as galvanized steel including hot dipped, electrogalvanized steel and galvanealed steel.

The adhesive coatings may be brushed, rolled, sprayed, dotted, knifed, cartridge-applied, especially from a dual cartridge; or otherwise applied to one substrate, but preferably to both substrates to desired thickness preferably not to exceed 60 mils. The substrates may be clamped for firmness during cure in those installations where relative movement of the two substrates might be expected. For example, to adhere metal surfaces, an adherent quantity of the adhesive composition is applied to one surface, preferably to both surfaces, and the surfaces are confronted with the adhesive composition therebetween. The adhesive should have a thickness less than 60 mils for optimum results. The smoothness of the surfaces and their clearance (e.g., in the case of nuts and bolts) will determine the required film thickness for optimum bonding. The two metal surfaces and the interposed adhesive composition are maintained in engagement until the said adhesive composition has cured sufficiently to bond the said surfaces. Incorporation of glass beads to control bondline thickness is preferred especially in hemming operations, as is taught in U.S. Pat. Nos. 5,487,803 and 5,470,416. The beads may be any hard material, e.g. glass, ceramic, polymeric, and may be non-spherical but preferably are spherical in shape. Beads are preferably made of glass and incorporated into the adhesive in a concentration which is sufficient to prevent the beads from becoming partially embedded in the surfaces of the steel panels during the hemming operation, which can result in “read through” to the outer panel surface. The beads should have a diameter sufficiently low to provide a strong joint and sufficiently high such that the beads are effective for control of bond thickness. Useful bead diameter ranges from 0.003 to 0.030 inches (0.07 to 0.76 mm) with 0.009 in. (0.22 mm) being a preferred diameter. The concentration of beads in the final applied adhesive mixture can range typically from 3% to 20% of the total weight of A- and B-sides.

The method of making a hemmed joint of inner (first) and outer (second) sheet metal panels includes applying adhesive on the inner side of the second panel, adjacent to the point of a fold of the edge portion of the second panel, aligning an edge of the first panel in overlying relationship contacting the adhesive in a hemming step of folding the edge of the second panel to overlap the edge of the first panel. The area where first and second panels contact the adhesive defines the bonding joint. A hemming die is pressed downward to bend the edge of the second member over the edge of first panel. By completing the fold, adhesive spreads throughout the area of the joint, and preferably does protrude beyond the fold. The adhesive according to the present invention contains incompressible beads preventing excessive squeeze-out on completion of the hemming operation. The method of joining metal panels in a hem flange joint which includes a bonding area containing adhesive and first and second metal panels, comprises the steps of:

a) applying to the second panel a 2-part adhesive mixture in a bead line parallel and proximate to an edge on a fold or to be folded,

b) aligning an edge of the first panel over the adhesive bead line, and pressing the folded edge of said second panel over the surface of the edge of said first panel in a hemming step, causing said panels to sandwich said adhesive, and said adhesive to spread within the bond area, and

c) completing the folding of the edge by applying pressure to the edge of said first panel within the hem bonding joint.

### EXAMPLES

The following examples are provided for illustration purposes only and are not intended to limit the scope of the invention in any manner.

### Example 1

Araldite™ GY-6010 epoxy resin was added to the B-side of an acrylic structural adhesive at from 0 to 18 weight percent on total weight in 3 percent increments. The adhesive was cured using 2 weight percent of benzoyl peroxide (50% in a carrier) in the B-side. The A- and B-sides were hand-mixed using a split tongue blade. Examples 1-A to 1-H employed THFMA as primary monomer, and the epoxy content was varied from 0% to 18%, and rubber to epoxy ratio from 1.69-infinity. These results are presented in Table 1. The adhesives were evaluated for lap shear, hot strength, and T-peel performance Electrogalvanized steel panels (1″×4″/2.54 cm.×10.1 cm) were used in all three tests. The coupons were dry rag-wiped and bonded at overlaps of 0.5 in./1.44 cm² for room temperature and hot strength lap shear, and 3 in.2/19.3 cm² for T-peel.

TABLE 1

| | Example | | | | | | | |
|---|---|---|---|---|---|---|---|---|
| | 1-A | 1-B | 1-C | 1-D | 1-E | 1-F | 1-G | 1-H (control) |
| Epoxy wt. % | 18% | 15% | 12% | 9% | 6% | 3% | 0% | 9.5% |
| Rubber: epoxy (by wt.) | 1.69 | 2.10 | 2.73 | 3.77 | 5.84 | 12.1 | ∞ | 3.26 |
| Lap Shear (psi) | 1926 | 1843 | 2053 | 2019 | 2122 | 2160 | 2005 | 2109 |
| T-Peel (pli) | 39 | 40 | 40 | 41 | 48 | 51 | 44 | 41 |
| Hot Strength (psi) | 142 | 167 | 182 | 179 | 198 | 172 | 182 | 218 |

All samples were averages of six (6) specimens. The lap shear and T-peel samples were allowed to cure at room temperature for 4 hours then post-baked for 30 minutes at 150° C. The hot strength samples were cured at room temperature for 90 minutes, then pulled at 190° C. when the bond line temperature reached 190° C. The results in Table 1 indicate that the best epoxy resin levels were between 3 and 6 weight percent.

### Example 2

| A-side | WT. % |
|---|---|
| Methacrylate ester* | 26.68 |
| Diethanol-para-toluidine | 1.300 |
| HEMA-Phosphate | 3.110 |
| Ethoxylated Epoxy-dimethacrylate | 3.500 |
| HEMA-phthalate | 2.210 |
| Primary toughener | 38.112 |
| Auxiliary toughener (mixed in monomer) | 2.26 |
| Cure rate moderator | 0.070 |
| Inhibitor | 0.004 |
| Hindered tri substituted phenol | 0.003 |
| Wollastonite | 12.140 |
| Fumed silica | 3.000 |
| Glass beads(0.25 mm diameter) | 7.600 |
| Tinting dye | 0.005 |
| Total | 100.00 |

$* \{ \begin{matrix}2 \text{-} A \text{:} THF \text{-} methacrylate \\ 2 \text{-} B \text{:} THF \text{-} methacrylate \\ 2 \text{-} C \text{:} 3 \text{,} 3 \text{,} 5 \text{-} trimethylcyclohexyl methacrylate \\ 2 \text{-} D \text{:} 3 \text{,} 3 \text{,} 5 \text{-} trimethylcyclohexyl methacrylate\end{matrix}$

| B side | Dry Weight % |
|---|---|
| GY 6010 Epoxy Resin | 60.00 |
| Benzoyl peroxide 50% | 12.00 |
| in plasticizer | 12.00 |
| Calcium carbonate | 15.00 |
| Fumed silica | 1.00 |
| | 100.00 |

Six samples were prepared for each test according to the same procedure described in Example 1. The adhesive mixture was applied to dry rage wiped electro-galvanized steel substrates using 50 cc (10:1 or 4:1 vol. mix ratio) cartridges equipped with static mixers. T-peel and lap shear samples were allowed to cure overnight at room temperature, and then post-baked for 30 minutes at 150° C. Hot strength samples were not post-baked. An Instron® test method was performed using a crosshead speed of 2 inches per minute for all of the test series. Hot Strength was measured at 190° C. in an Instron Environmental chamber.

TABLE 2

| | Example | | | |
|---|---|---|---|---|
| | 2-A | 2-B | 2-C | 2-D |
| | Mix ratio | | | |
| | 4:1 | 10:1 | 4:1 | 10:1 |
| Rubber/epoxy (by wt.) | 3.4 | 6.73 | 3.4 | 6.73 |
| Lap Shear (psi) | 2043 | 2356 | 1842 | 2334 |
| T-Peel (pli) | 42 | 48 | 46 | 70 |

Surprising improvements are noted in T-peel and lap shear tests when the mix ratio is increased from 4:1 to 10:1. Surprising improvements in T-peel were also observed in the embodiments utilizing the preferred methacrylate esters which exhibit homopolymer Tg's above 105° C.

### Example 3

Adhesives in this example were used to bond ACT 60G hot dipped galvanized steel to itself. The steel panel was cut into 1″×4″ (2.54×10.16 cm.) coupons for lap shear and T-peel testing, which were cleaned with methyl ethyl ketone, then treated with 9.7 mg/4 in² (25.8 cm²) of lubricating oil to simulate industrial application. For impact testing, the 25 mm×90 mm coupons were bent according to ISO 11343 with a bond line area of 25 mm×30 mm, and were surface-pretreated in the same way. Adhesives were dispensed from a 2-pack syringe at 10:1 volume mix ratio. The assembled parts were allowed to cure at room temperature for 4 hours, followed by post-backing at 150° C. for 30 minutes. The lap shear samples had an overlap of 0.5 in.2/1.44 cm², T-peel samples had a 3 in²/19.3 cm² overlap, and the impact samples had a 30 mm overlap.

Lap shear, T-peel, and high speed wedge impact testing were performed on bonded metal samples. The pull speed was 2″/min (5.08 cm./min) for lap shear and T-peel tests; five (5) sample specimens were measured and averaged for each test. The high speed impact wedge peel test was conducted according to ISO 11343 and Ford Laboratory Test Method BU 121-01. An Instron Drop Tower Impact Tester, Dynatup Model 9250HV was used. The wedge fixture was designed by the Ford Test Method BU 121-01. A potential energy of 155 J at a velocity of 3.5 m/sec is delivered at the impact. The Impulse® Data Acquisition System was used for data calculation; ten (10) sample specimens were tested for each adhesive formulation. According to ISO 11343, the average fracture force and fracture energy for each set were obtained by discarding the first 25% and the last 10% of the data. Average fracture energy and force (J) is reported and bond failure mode is noted. The results are reported in Table 3.

| A-side | WT. % |
|---|---|
| monomer* | 26.24 |
| N,N-diethanol-p-toluidine | 1.75 |
| HEMA-Phosphate | 3.11 |
| dimethacrylate crosslinking monomer | 3.50 |
| HEMA-phthalate | 2.21 |
| Primary toughener GMA-CTBN | 38.11 |
| Aux. toughener (mixed in monomer*) | 2.26 |
| Cure rate moderator (mixed in monomer*) | 0.007 |
| Inhibitor | 0.004 |
| Hindered tri substituted phenol | 0.003 |
| Wollastonite | 12.140 |
| Silicate thixotrope | 3.000 |
| Glass beads (0.25 mm diameter) | 7.6 |
| Total | 100.00 |
| Primary and auxiliary rubber content | 40.37 |

*Monomers:
3-1 3,3,5-trimethylcyclohexylmethacrylate (TMCHMA)
3-2 3,5-dimethylcyclohexylmethacrylate (DMCHMA)
3-3 2-isopropyl 5-methyl cyclohexylmethacrylate (iPMCHMA)
3-4 4-t-butyl-cyclohexylmethacrylate (t-BCHMA)
3-5 tetrahydrofurfurylmethacrylate (THFMA)
Commercial A: (THFMA)
Commercial B: (THFMA)

| B-Side | Dry Weight % |
|---|---|
| Bis-A Epoxy Resin | 50-70% |
| Benzoyl peroxide 50%* | 16-22% |
| *Plasticizer | 16-22% |
| Inorganic filler | 10-20% |
| Fumed silica | 1-3% |
| Total | to 100% |

TABLE 3

| | Rubber: | Primary | Lap Shear | T-Peel | Impact |
|---|---|---|---|---|---|
| A-Side | Epoxy | Monomer | (psi) | (pli) | (J) |
| 3-1 | 6.7 | TMCHMA | 1818 ± 43 | 49.5 ± 1.5 | 18.5 ± 1.1 |
| | | | 100 c | 85 c, 15 tlc | 76 c, 24 tlc |
| 3-2 | 6.7 | DMCHMA | 1723 ± 11 | 42.4 ± 3.4 | 19.7 ± 0.9 |
| | | | 100 c | 76 c, 24 tlc | 26 c, 74 tlc |
| 3-3 | 6.7 | IPMCHMA | 1758 ± 63 | 42.6 ± 3.6 | 20.4 ± 0.8 |
| | | | 100 c | 96 c, 4 tlc | 76 c, 24 tlc |
| 3-4 | 6.7 | t-BCHMA | 1997 ± 49 | 49.8 ± 3.4 | 16.1 ± 1.0 |
| | | | 100 c | 84 c, 16 tlc | 74 c, 26 tlc |
| 3-5 | 6.7 | THFMA | 1954 ± 136 | 41.2 ± 2.2 | 15.6 ± 0.7 |
| | | | 84 c, 16 tlc | 100 tlc | 74 c, 26 tlc |
| Commercial A | 3.2 | THFMA | 1750 ± 80 | 30.91 ± 3 | — |
| Versilok ® 263/264 | | | 100 c | 100 tlc | — |
| Commercial B | 3.3 | THFMA | 1850 ± 80 | 36.67 ± .91 | 14.9 ± 1.1 |
| Versilok ® 262/254 | | | 100 c | 100 tlc | — |

Failure modes: c = cohesive, tlc = thin layer cohesive, numbers report % of bond area.

From the above results it can be seen that Examples 3-1-3-4 exhibit improved T-peel and impact strength over the control and commercial adhesives in the effective rubber-to-epoxy ratio.

The foregoing description is, at present, considered to represent the preferred embodiments of the present invention. However, it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

What is claimed is:

1. An ambient temperature curing, two-part liquid structural adhesive composition comprising part A and part B wherein:
part A comprises:
a monomer selected from group (a) and (b), wherein (a) is 4-(C₃-C₁₀ alkyl) cyclohexylmethacrylate, 2,5-(C₁-C₆ alkyl) cyclohexylmethacrylate, 3,5-(C₁-C₆ alkyl) cyclohexylmethacrylate, 3,3,4-(C₁-C₄ alkyl) cyclohexylmethacrylate, 3,3,5-(C₁-C₄ alkyl) cyclohexylmethacrylate, 3,3,5,5-(C₁-C₄ alkyl) cyclohexylmethacrylate, and (b) is C₇-C₁₀ alkyl methacrylates selected from bornyl (C₁₀H₁₇) methacrylate, and isobornyl methacrylate;
a multifunctional crosslinking monomer,
optional cure rate modifier,
an inorganic filler,
an adhesion promoter;
a reactive diluent,
a solid and/or liquid toughener, and
a reducing agent; and wherein
said part B comprises:
an epoxy resin,
an oxidizer,
a non-reactive liquid carrier,
an inorganic filler,
a thixotropic agent, and
optional plasticizer, in addition to said liquid carrier, wherein the weight ratio of solid and/or liquid toughener to epoxy resin is from 4:1 to 11:1.

2. An adhesive composition according to claim 1 wherein part B further comprises a liquid elastomer modified epoxy.

3. An adhesive composition according to claim 1 wherein the toughener in the A-side contains a liquid elastomer toughener and a solid triblock copolymer toughener.

4. An adhesive composition according to claim 3 wherein the weight ratio of liquid elastomer toughener to tri-block copolymer toughener is from 5:1 to 20:1.

5. An adhesive composition according to claim 1 wherein the toughener in the A-side is selected from the reaction product of glycidal acrylate and hydroxyl-terminated polybutadiene polymer and the reaction product of glycidal methacrylate and carboxyl-terminated polybutadiene polymer.

6. An adhesive according to claim 1 wherein the reducing agent is selected from N,N-diisopropanol-p-chloroaniline; N,N-diisopropanol-p-bromoaniline; N,N-diisopropanol-p-bromo-m-methylaniline; N,N-dimethyl-p-chloroaniline; N,N-dimethyl-p-bromoaniline; N,N-diethyl-p-chloroaniline; and N,N-diethyl-p-bromoaniline, N,N-diisopropanol-p-methyl aniline; N,N-dimethyl aniline, and N,N-diethanol-p-dimethyl aniline.

7. An adhesive according to claim 3 wherein the toughener in A-side comprises a liquid acrylated butadiene and a solid A-B-A block copolymer wherein the A block is selected from styrene, ring alkylated styrene or a mixture thereof and the B block is an elastomeric segment derived from a conjugated diene or olefin.

8. The adhesive of claim 1 comprising from about 3 to about 6% by wt. of said epoxy resin.

9. The adhesive of claim 1 wherein said ethylenic unsaturated methacrylic ester is selected from the group consisting of 2-isopropyl-5-methyl cyclohexylmethacrylate, 3,5-dimethylcyclohexyl methacrylate, 3,3,5-trimethylcyclohexyl methacrylate, 3,4,5-trimethylcyclohexyl methacrylate, 4-tert-butylcyclohexyl methacrylate, 3,3,5,5-tetramethylcyclohexyl methacrylate, bormyl methacrylate, and isobornyl methacrylate.

10. The adhesive of claim 1 wherein said A-side comprises on weight basis, 15 to 35% of the olefinic monomer which is selected from 4-t-butyl-cyclohexylmethacrylate, 2-isopropyl 5-methyl cyclohexylmethacrylate, 3,5-dimethyl cyclohexylmethacrylate, 3,3,5-trimethylcyclohexyl methacrylate, 3,4,5-trimethylcyclohexyl methacrylate, 3,3,5,5-tetramethylcyclohexyl methacrylate, bornyl methacrylate, and isobornyl methacrylate,
2 to 10% of the multifunctional crosslinking monomer,
0.005 to 0.25% of the cure rate modifier,
15 to 30% of the inorganic filler,
1 to 6% of the adhesion promoter,
1 to 10% of the reactive diluent,
30 to 42% of the solid and/or liquid toughener, and
the B-Side comprises
40 to 70% of the epoxy resin,
3 to 12% of the oxidizer,
3 to 12% of the non-reactive liquid carrier,
10 to 40% of the inorganic filler, and
2 to 8% of the thixotropic agent.

11. The adhesive of claim 1 wherein said adhesion promoter is selected from 2-methacryloyloxyethyl phosphate, bis-(2-methacryloxyloxyethyl)phosphate, 2-acryloyloxyethyl phosphate, bis-(2-acryloyloxyethyl)phosphate, methyl-(2-methacryloyloxyethyl)phosphate, ethyl methacryloyloxyethyl phosphate, methyl acryloyloxyethyl phosphate, ethyl acryloyloxyethyl phosphate, propyl acryloyloxyethyl phosphate, isobutyl acryloyloxyethyl phosphate, and ethylhexyl acryloyloxyethyl phosphate.

12. The adhesive of claim 1 wherein said reactive diluent is mono-2-(methacryloyloxy)ethyl phthalate.

13. The adhesive of claim 1 wherein the monomer is selected from 4-t-butyl-cyclohexylmethacrylate, 2-isopropyl 5-methyl cyclohexylmethacrylate, 3,5-dimethyl cyclohexylmethacrylate, 3,3,5-trimethylcyclohexyl methacrylate, 3,4,5-trimethylcyclohexyl methacrylate, 3,3,5,5-tetramethylcyclohexyl methacrylate, bornyl methacrylate, and isobornyl methacrylate;
the multifunctional crosslinking monomer is selected from trimethylolpropane trimethacrylate, hexanediol dimethacrylate, trimethylolethane trimethacrylate, Bisphenol-A dimethacrylate and ethoxylated bisphenol-A dimethacrylate;
the cure rate modifier is present and selected from α-methyl styrene, 3-methyl styrene, and 4-methyl styrene;
the inorganic filler is selected from mica and wollastonite;
the adhesion promoter is selected from alkenyl functional silane, zinc diacrylate, zinc dimethacrylate, unsaturated mono-ester of phosphonic acid, unsaturated di-ester of phosphonic acid, unsaturated monoester of phosphoric acid, and unsaturated di-ester of phosphoric acid;
the reactive diluent is a partial ester of a carboxylic acid anhydride esterified with a hydroxy functional acrylate or methacrylate monomer;
the toughener is glycidyl methacrylate-terminated liquid polybutadiene;
the reducing agent is an aromatic tertiary amine; and
in said B-Side,the epoxy resin is bisphenol diglycidal ether,
the oxidizer is an organic peroxide,
the liquid carrier is selected from phthalate ester, adipate ester, polyester, benzoate ester, and
a mixture thereof,
the inorganic filler in sides A and B are selected from titanium dioxide, wollastonite and mixtures thereof, and the thixotropic agent is fumed silica.

14. A two-part acrylic structural adhesive supplied in a volume mix ratio of parts A:B of from 6:1 to 14:1, comprising on weight basis:
part A comprising:
(a) 10-90% of an olefinic monomer selected from the group consisting of (meth)acrylic acid;
esters, amides or nitriles of (meth)acrylic acid; maleate esters; fumarate esters; vinyl esters;
conjugated dienes; itaconic acid; styrenic compounds; and vinylidene halides;
(b) 20-50% of a primary toughener;
(c) 0-15% of an auxiliary toughener;
(d) 0-20% of a phosphorus adhesion promoter compound having one or more olefinic groups,
(e) 0.05-10% of at least one reducing agent; and
and part B comprising, an epoxy resin, and a bonding activator containing an oxidizing agent wherein the epoxy resin is present at 3-6 wt. % on total weight of A- and B-sides.

15. The adhesive for claim 14 wherein the weight ratio of primary and auxiliary toughener to epoxy resin in from 4:1 to 11:1.

16. The adhesive of claim 14 wherein said olefinic monomer is tetrahydrofurfurylmethacrylate, and said adhesive further comprises a partial ester of a carboxylic acid anhydride esterified with a hydroxy functional acrylate or methacrylate monomer.

17. The adhesive of claim 16 wherein said partial ester is mono-2-(methacryloyloxy)ethyl phthalate.

18. A process for joining a first and second steel panels comprising the steps of:
a) applying to the second panel the adhesive according to claim 1 in a bead line parallel and proximate to the edge of the second panel to be folded,
b) aligning an edge of the first panel over the adhesive bead line, and folding the edge of said second panel over the edge of said first panel in a hemming step, causing said panels to sandwich said adhesive spreading it within the bond area, and
c) completing the folding of the edge of the second panel by applying pressure.
